(19) United States
(12) Patent Application Publication
(10) Pub. No.: US 2006/0175361 A1
(43) Pub. Date: Aug. 10, 2006

(54) Container closure with shape memory

(75) Inventor: Wolfgang Heukamp, Swisttal (DE)

Correspondence Address: THE FIRM OF KARL F ROSS, 5676 RIVERDALE AVENUE, PO BOX 900, RIVERDALE (BRONX), NY, 10471-0900, US

(73) Assignee: GEORG MENSHEN GmbH & Co. KG

(21) Appl. No.: 11/348,531

(22) Filed: Feb. 6, 2006

(30) Foreign Application Priority Data
Feb. 4, 2005 (DE) 102005005167.7

(51) Int. Cl. B67D 3/00

(52) U.S. Cl. 222/534; 222/153.14

(57) ABSTRACT

A container has a body formed with an opening and adapted to hold a fluent material that can exit the body through the opening. A closure fittable with the opening is displaceable on the body between a closed position blocking flow out of the body through the opening and an open position permitting flow out of the body through the opening. Respective interengageable formations on the closure and on the body include one formation of a shape-memory material and deforming on temperature change past a predetermined transition temperature from a first deformed shape to a second memory shape. This one formation blocks movement of the closure on the body between one of the positions and the other position when in one of the shapes and permits movement of the closure on the body between the other of the positions and the one position when in the other of the shapes.

### FIELD OF THE INVENTION

The present invention relates to a closure for a container. More particularly this invention concerns a screw, flip, or plug type closure for a bottle or the like.

### BACKGROUND OF THE INVENTION

It is standard to provide a container with an openable closure fittable to a body of the container and movable between a closed position blocking flow of a fluent material, typically a liquid, out of the container and an open position permitting such flow.

Child-proof systems are known that require biaxial movement or some other manipulation making it difficult or impossible for a child to open a container. In addition tamper-indicating systems are well known that provide an indication if the container has been opened.

There is a need, however, for a closure that can only be operated under certain circumstances. For instance, certain medications or medical products, e.g. blood bags, and some foodstuffs are unfit for use if heated above or cooled below a predetermined threshold temperature. While it is known to provide some sort of indicator on the container to show if the threshold temperature has been passed, such a system requires vigilance on the part of the user and does not actually prevent the contained material from being used.

### OBJECTS OF THE INVENTION

It is therefore an object of the present invention to provide an improved container closure.

Another object is the provision of such an improved container closure that overcomes the above-given disadvantages, in particular that can positively prevent or enable opening of a container when it has been heated above or cooled below a predetermined threshold temperature.

### SUMMARY OF THE INVENTION

A container has according to the invention a body formed with an opening and adapted to hold a fluent material that can exit the body through the opening. A closure fittable with the opening is displaceable on the body between a closed position blocking flow out of the body through the opening and an open position permitting flow out of the body through the opening. Respective interengageable formations on the closure and on the body include one formation of a shape-memory material and deforming on temperature change past a predetermined transition temperature from a first deformed shape to a second memory shape. This one formation blocks movement of the closure on the body between one of the positions and the other position when in one of the shapes and permits movement of the closure on the body between the other of the positions and the one position when in the other of the shapes.

Thus the instant invention exploits the smart properties of shape-memory materials, either polymers. Such materials typically have a crystalline or molecular structure such that they can deformed radically and will retain the deformed position, aping conventional plastic deformation. Such deformation can either be done below the transition temperature or above the transition temperature, in a state in which the material is soft. After the deformation the material is subsequently cooled below the transition temperature to lock in the deformed shape. When, however, heated above the transition temperature, such smart materials revert to their so-called memory shape, that is the shape they had before being deformed. This reformation is essentially 100%, that is the seemingly “plastic” deformation is completely reversed and the material is again stable. The reformation shape change takes place fairly suddenly.

The instant invention therefore makes it possible to design, for example, a bottle cap that cannot be removed or can only be removed if the bottle is heated above, or conversely if it is cooled below a predetermined temperature, which in fact is the transition temperature of the shape-memory material. Thus use of a fragile foodstuff or blood product can be prevented. Conversely it is possible to ensure that a product is only available if heated above an activation or sterilization temperature or maintained below a safe storage temperature.

The first shape according to the invention can be the memory shape of the one formation and the second shape the deformed shape of the one formation. Alternately, depending on use, the first shape is the deformed shape of the one formation and the second shape is the memory shape of the one formation. Similarly, the memory shape, that is the shape reassumed above the transition temperature, can serve for blocking or unblocking the container. With conventional smart shape-memory materials the transition temperature can range from +20° C. to +70° C. For example the Veriflex™ (crg-industries.com) polymer has a transition temperature of 62° C.

As mentioned above, the closure according to the invention can be a screw cap. The body and screw cap have interengaging screw threads so that the screw cap can be rotated about an axis to screw it onto and off the body. The formation can project axially or radially toward each other. More particularly, this screw cap can comprise an outer cup-shaped part and a liner therein formed with the respective screwthread and the one formation. Child-proofing formations can be provided between the cap and the liner for rotationally coupling the cap to the liner only when the cap is shifted axially relative to the liner. Here the one formation is an angled arm extending generally downward or inward from the screw cap and the other formation is a radially outwardly projecting bump on the body.

In another system according to the invention the closure in a spray or squirt-bottle system is a spout having a passage and pivotal between the open position in which the passage is aligned with the opening and the closed position in which the passage is not aligned with the opening. The one formation is carried on the spout and the other formation is carried on the body.

It is also within the scope of this invention for the closure to be a plug sealingly engageable in the closed position in the opening. This plug can move either across the opening on shifting from the closed to the open position, or simply fold back away from the opening.

In a flip-top cap arrangement the body includes a flip top carrying the plug and pivotally displaceable between the closed position and the open position in which the plug is offset from the opening. The one formation is at least one arm having a barbed end and engageable through a hole in the body having an edge forming the other formation. The flip top can have two such arms that are relatively closely spaced and fittable through the hole in the other position. With the plug the formation is a web connecting the plug to the body. As mentioned above the plug moves pivotally either about an axis generally parallel to an axis of the hole on deformation of the web forming the one formation between the shapes or pivotally about an axis generally tangential to the hole on deformation of the web forming the one formation between the shapes. With the plug arrangement there is a ring set in the body and coaxially surrounding the opening. The web and plug are unitarily formed with the ring.

In a particularly simple embodiment, the one formation and the closure are the same part and are formed as a plurality of interfitting segments forming a basically closed conical shape in the closed position.

The instant invention can thus be considered to be a method of controlling use of a contained substance, in that it actively prevents or allows a contained substance to be used only when the container has not moved above or below the transition temperature. Use of heat-sensitive delicate medical supplies or foodstuffs can be prevented if they are heated above a certain temperature or prefilled baby bottles can only be used when heated above a sterilizing temperature, depending on whether the memory position is used to prevent the closure from moving from the closed to the open position or vice versa.

### BRIEF DESCRIPTION OF THE DRAWING

The above and other objects, features, and advantages will become more readily apparent from the following description, it being understood that any feature described with reference to one embodiment of the invention can be used where possible with any other embodiment and that reference numerals or letters not specifically mentioned with reference to one figure but identical to those of another refer to structure that is functionally if not structurally identical. In the accompanying drawing:

FIG. 1a is an axial section through a bottle cap;

FIG. 1b is a side view through a shape-memory insert for the cap in the locking position;

FIG. 1c is a side view of an upper neck portion of a bottle;

FIG. 1d is a view like FIG. 1b but in the freeing position;

FIG. 1e is a view like FIG. 1b but from the other side;

FIG. 2 is an axial section through a variant of the structure of FIGS. 1a-1e;

FIG. 3a is a view like FIG. 2 of yet another cap in accordance with the invention;

FIGS. 3b and 3c are views of the liner of the FIG. 3a cap in the freeing and blocking positions;

FIG. 4a is a view like FIG. 2 of yet another cap according to the invention;

FIGS. 4b and 4c are side views of the liner ring of the FIG. 4a cap in the freeing and blocking positions;

FIGS. 4d and 4e are axial end views of the rings as shown in FIGS. 4b and 4c;

FIG. 5a is an axial section through a spout or squirt-type cap according to the invention;

FIG. 5b is a section through the FIG. 5a cap but taken along a section plane offset by 90° to that of FIG. 5a;

FIG. 5c is a side view of the spout of the FIG. 5a cap;

FIGS. 5d and 5e is a variant on the system of FIG. 5b;

FIG. 5f is a detail sectional view of FIG. 5e;

FIG. 6a is an axial section through a flip-type cap in accordance with the invention;

FIGS. 6b and 6c are detail views illustrating the cap in the locked and unlocked position;

FIG. 7a is an axial section through yet another cap according to the invention;

FIGS. 7b, 7c, and 7d are sectional detail views of the cap of FIG. 7a;

FIG. 7e is a variant on the system of FIGS. 7a-7d;

FIGS. 8a and 8b are axial sections through a valve system according to the invention in the open and closed conditions;

FIGS. 9a and 9b are axial sections through another valve according to the invention in the open and closed conditions; and

FIGS. 10a and 10b are end views through yet another valve in accordance with the invention in the open and closed conditions.

### SPECIFIC DESCRIPTION

As seen in FIGS. 1a-1e a container according to the invention has a body 1 formed with a neck 2 defining an opening 3 and formed with an external screwthread 4. A closure or cap 5 fittable over the neck 2 has a complementary internal screwthread 6 and can be tightened down over the neck 2 to close the opening 3 as is well known in the art.

According to the invention a shape-memory insert ring 7 is fitted in the cap 5 and has external ridges or splines 17 that mate with internal grooves or splines 18 of the cap 5 to rotationally lock the ring 7 in the cap 5. A pair of formations, here angled arms 8 both facing in the same direction and projecting axially downward from the ring 7, are formed on a lower edge of the insert 7 and can interfere with a locking formation or ridge 9 on the neck 2. These arms 8 are limitedly radially deflectable, and the outer surface of the formation 9 is a spiral ramp so that the cap 5 with the insert 7 can be screwed onto the neck 2, but when projecting as shown in FIGS. 1b and 1e these arms 8 solidly prevent the cap or closure 5 from being unscrewed to open the container.

The shape memory function of the arms 8 is such that to start with the arms 8 are in their low-temperature deformed shape and are retracted as shown in FIG. 8 so as not to project into the path of the ridge 9. When heated to a transition temperature, they assume the projecting blocking position shown in FIGS. 1b and 1e.

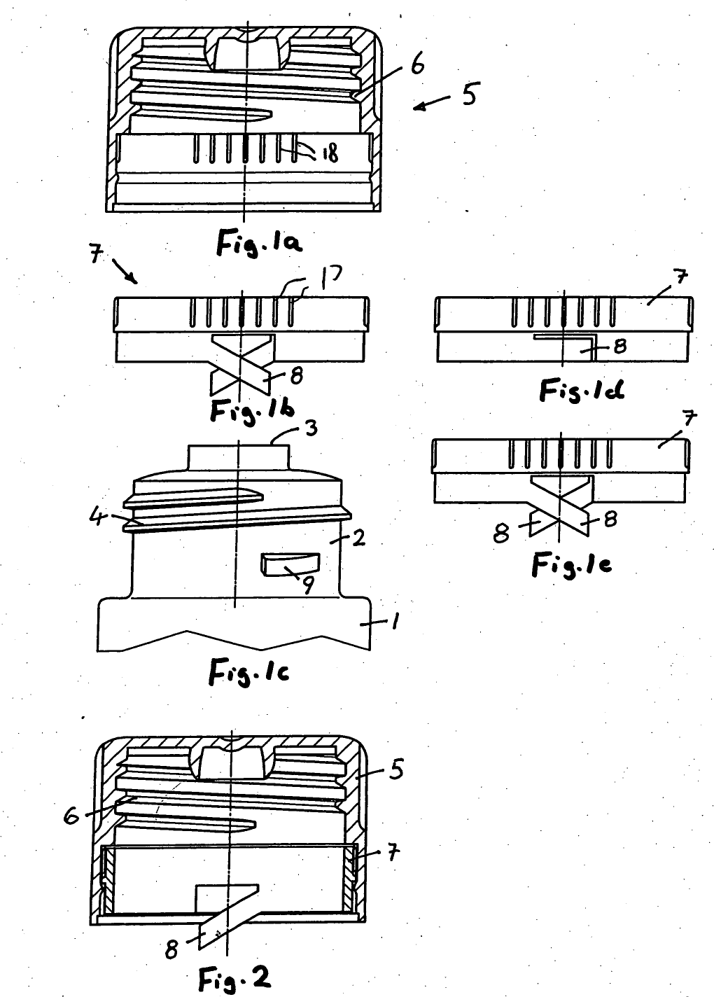

The embodiment of FIG. 2 is different from that of FIGS. 1a-1e in that the arms 8 project downward for a blocking function when in the memory position. The cap is delivered to the filling plant with the arms 8 deformed up into the unblocking position. Only when the filled container with the cap is heated past a predetermined transition temperature do they permanently assume the illustrated projecting position.

Without departing from the invention, the shape-memory arms 8 could also be provided on the body 1 of the container, or on its neck 2.

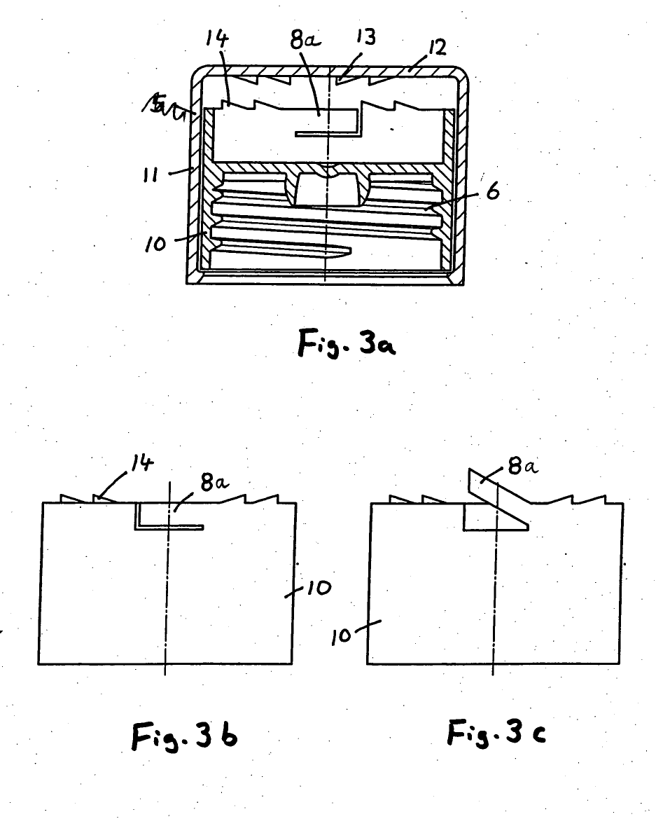

FIGS. 3a-3c show a system where a cap 11 is provided with a liner sleeve 10 itself having the screwthread 6 and formed on its end facing an end wall 12 of the cap 11 with shape-memory arms 8a engageable with an annular array of barbs 13 formed on an inner face of this cap 11. These barbs 13 can also coact with barbs 14 formed on the outer end of the liner 11, which barbs 14 are effective angularly oppositely to the shape-memory arms 8a.

In this arrangement the cap 11 has a child proofing function, in that the barbs 13 can only be engaged with the barbs 14 by axially pushing down on the cap to push the barbs 13 into engagement with the barbs 13, thereby rotationally coupling the cap 11 to the liner 10.

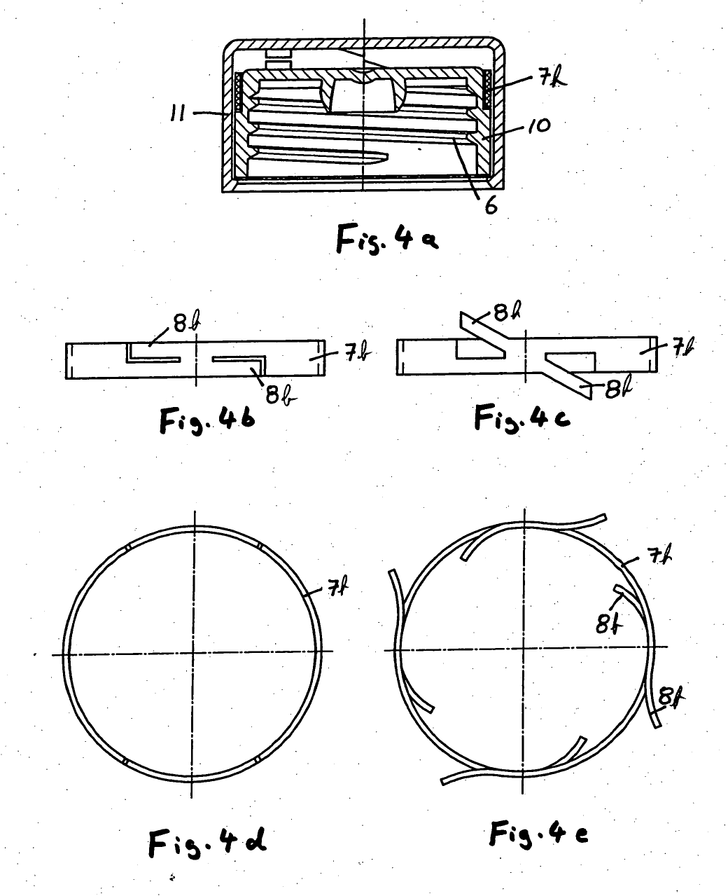

Here, the FIG. 3b position can be the deformed position, that is the position before the system has been heated above the shape-memory transition temperature, and the FIG. 3c position can be the memory position assumed after heating, or vice versa. FIGS. 4a through 4e show a system similar to that of FIGS. 3a-3c. Here, however, the arms 8b are formed on a thin ring 7b fitted radially between the liner 10 and the cap 11. The arms 8b can move from positions lying within the axial and radial outline of the ring 7b as shown in FIGS. 4b and 4d, or can project axially (FIG. 4c) and/or radially (FIG. 4e) therefrom. Once again the projecting position can be the memory position, that is the position assumed after heating or the deformed position it has before such heating.

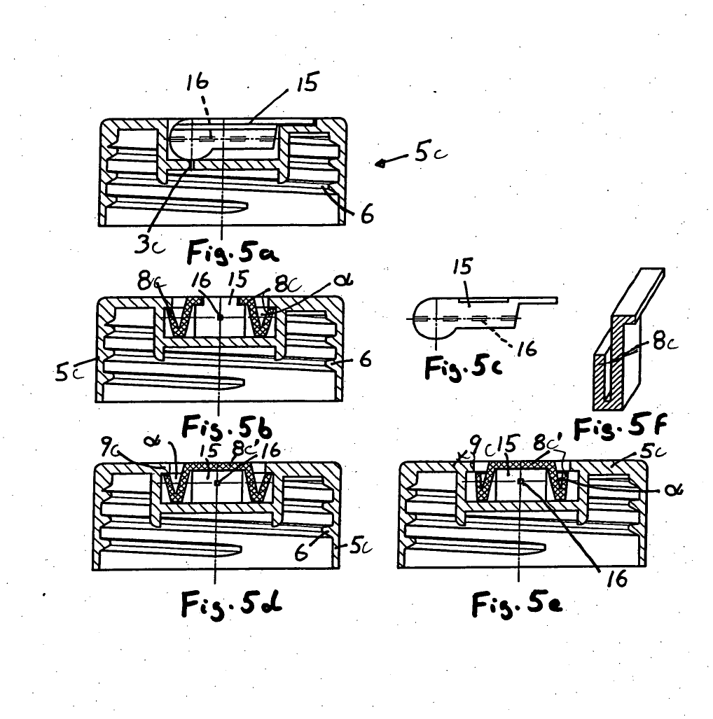

The system of FIGS. 5a-5f is a squirt cap 5c not itself normally taken off its container, but instead equipped with a pivotal spout 15 having a throughgoing passage 16 alignable in one angular position of the spout 15 with a hole 3c in the cap 6. Here the sides of the pivotal spout 15 are each provided as shown in FIG. 5b with a respective shape-memory wing 8c that can engage under a formation or lip 9c of the cap 5c, whereas in FIGS. 5d and 5e a single shape-memory body 8c reaches over the top of the spout 15. In one condition as shown in FIGS. 5b and 5d, either the memory shape or the deformed shape, the wings 8c project outward at a small acute angle a and prevent upward pivoting of the spout 15. In the other condition as shown in FIG. 5e such pivoting is possible. Thus the spout 15 can used either only after or only before heating to the transition temperature, or can prevent or enable use below the transition temperature.

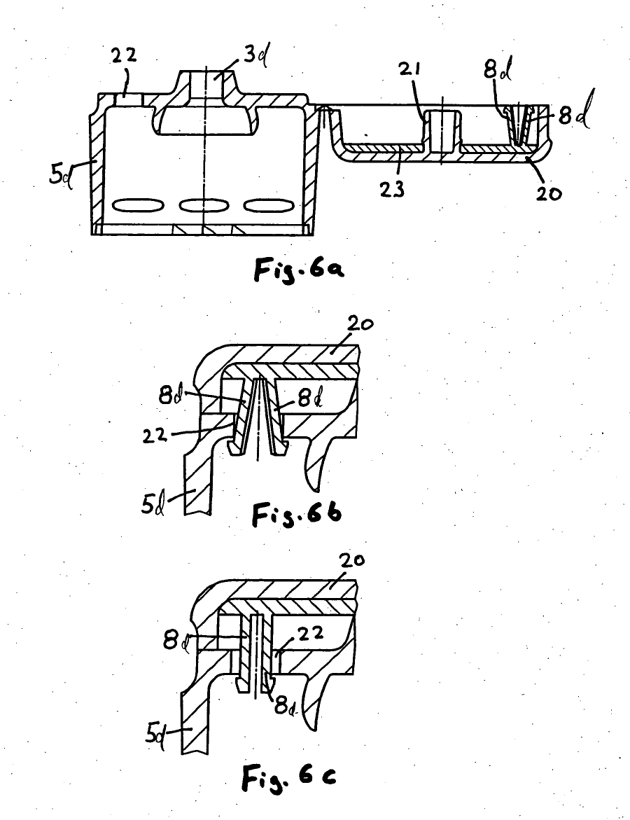

The system of FIGS. 6a-6c comprises a cap 5d having a central outlet hole 3c and provided with a flip top 20 having a plug formation 21 that can fit in and block the hole 3c. In addition a pair of shape-memory arms 8d project from a liner disk 23 on the underside of the cap 20 and can fit with barbed ends through a hole 22 constituting the locking formation of the cap 5d. When the arms 8d are spread as shown in FIG. 6b they inhibit raising of the cap part 20, but when extending parallel to each other they permit such raising. Once again, depending on use, the FIG. 6b position can be the memory-shape memory position and the FIG. 6c position the deformed position, or vice versa. In this embodiment it would be possible for the arms 8d to be centered in the plug 21 and engage through the hole 3d, making the hole 22 unnecessary.

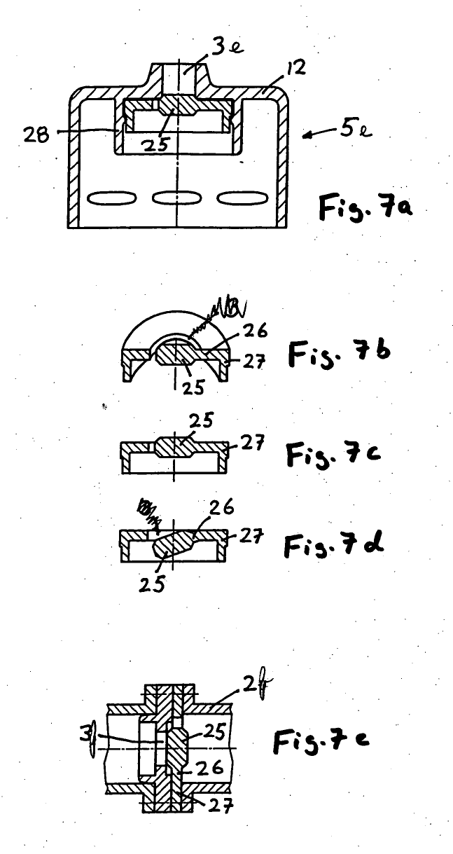

In FIGS. 7a-7d a cap 5e has a central hole 3e and its end wall 12 is formed with a collar 28 in which is set a ring 27 connected unitarily by a web 26 with a plug 25, all unitarily formed of shape-memory material. FIG. 7c shows the position with the plug 25 oriented to block the hole 3e, and FIG. 7d shows it in the open position.

FIG. 7e shows a similar system fitted to a hole 3f of a partition between two conduit ends 2f.

FIGS. 8a and 8b show how a plurality of conical segments 30 can move between a spread and open (FIG. 8a) and a fitted-together and closed (FIG. 8b) position. Such a structure can be fitted to a bottle or cap opening.

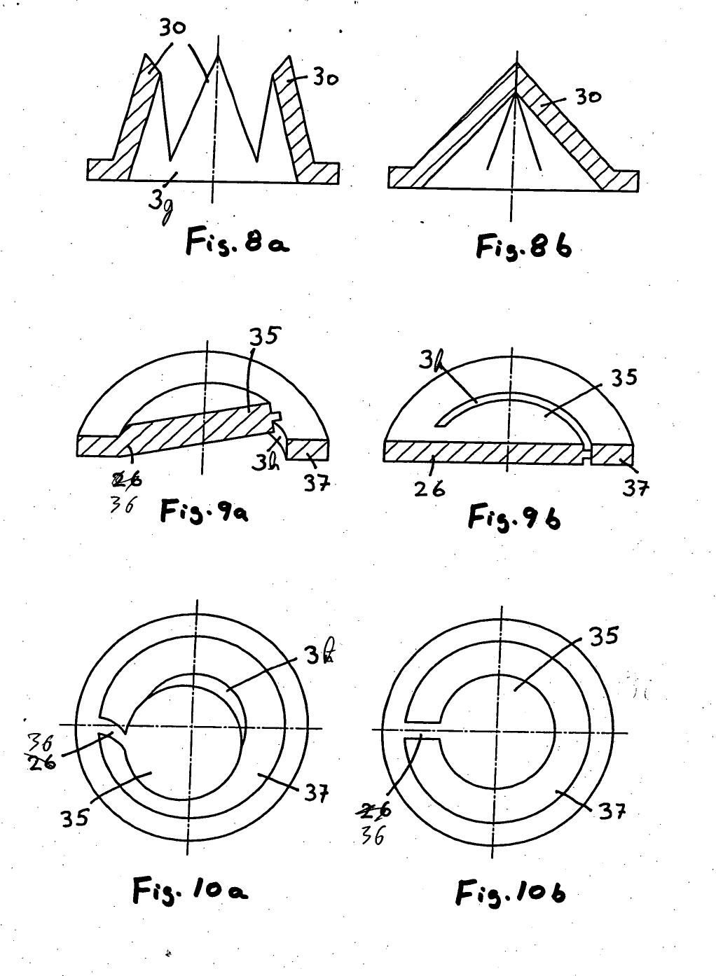

In FIGS. 9a and 9b a center shape-memory plug or disk 25 connected by a web 36 to an outer ring 37 can pivot about an axis parallel to the plane of the disk between an open (FIG. 9a) and closed (FIG. 9b) position.

FIGS. 10a and 10b show a system similar to that of FIGS. 9a and 9b, but here the disk 35 moves laterally to the side as it shifts between its original memory and deformed positions.

1. A container comprising:
a body formed with an opening and adapted to hold a fluent material that can exit the body through the opening;
a closure fittable with the opening and displaceable on the body between a closed position blocking flow out of the body through the opening and an open position permitting flow out of the body through the opening; and
respective interengageable formations on the closure and on the body, one of the formations being of a shape-memory material and deforming on temperature change past a predetermined transition temperature from a first deformed shape to a second memory shape, the one formation blocking movement of the closure on the body between one of the positions and the other position when in one of the shapes and permitting movement of the closure on the body between the other of the positions and the one position when in the other of the shapes.

2. The container defined in claim 1 wherein the first shape is the memory shape of the one formation and the second shape is the deformed shape of the one formation.

3. The container defined in claim 1 wherein the first shape is the deformed shape of the one formation and the second shape is the memory shape of the one formation.

4. The container defined in claim 1 wherein the closure is a screw cap, and the body and screw cap have interengaging screw threads, whereby the screw cap can be rotated about an axis to screw it onto and off the body, the formations projecting axially or radially toward each other.

5. The container defined in claim 4 wherein the screw cap comprises an outer cup-shaped part and a liner therein formed with the respective screwthread and the one formation.

6. The container defined in claim 5, further comprising
child-proofing formations between the cap and the liner for rotationally coupling the cap to the liner only when the cap is shifted axially relative to the liner.

7. The container defined in claim 4 wherein the one formation is an angled arm extending generally downward from the screw cap toward the container and the other formation is a radially outwardly projecting bump on the body.

8. The container defined in claim 1 wherein the closure is a spout having a passage and pivotal between the open position in which the passage is aligned with the opening and the closed position in which the passage is not aligned with the opening.

9. The container defined in claim 8 wherein the one formation is carried on the spout and the other formation is carried on the body.

10. The container defined in claim 1 wherein the closure is a plug sealingly engageable in the closed position in the opening.

11. The container defined in claim 10 wherein the body includes a flip top carrying the plug and pivotally displaceable between the closed position and the open position in which the plug is offset from the opening, the one formation being at least one arm having a barbed end and engageable through a hole in the body having an edge forming the other formation.

12. The container defined in claim 11 wherein the flip top has two such arms that are relatively closely spaced and fittable through the hole in the other position.

13. The container defined in claim 10 wherein the formation is a web connecting the plug to the body.

14. The container defined in claim 12 wherein the plug moves pivotally about an axis generally parallel to an axis of the hole on deformation of the web forming the one formation between the shapes.

15. The container defined in claim 12 wherein the plug moves pivotally about an axis generally tangential to the hole on deformation of the web forming the one formation between the shapes.

16. The container defined in claim 12, further comprising
a ring set in the body and coaxially surrounding the opening, the web and plug being unitarily formed with the ring.

17. The container defined in claim 1 wherein the one formation and the closure are the same part and are formed as a plurality of interfitting segments forming a basically closed conical shape in the closed position.

18. The container defined in claim 1 wherein the shape-memory material is a metal or plastic.

19. The container defined in claim 1 wherein the formations are generally identical segments that in the one shape fit together and block the opening and in the other shape spread apart and permit the material to exit through the opening.

20. The container defined in claim 1 wherein the closure is a disk fittable in the closed position in the opening, the one formation being a hinge carrying the disk.
